(19) United States
(12) Patent Application Publication
(10) Pub. No.: US 2026/0364640 A1
(43) Pub. Date: Nov. 19, 2026

(54) ARTICLE INSPECTION SYSTEM

(71) Applicant: ANRITSU CORPORATION, Kanagawa (JP)

(72) Inventors: Hiro KUMAZAWA, Kanagawa (JP); Naoya SAITO, Kanagawa (JP)

(21) Appl. No.: 19/365,291

(22) Filed: Oct. 22, 2025

(30) Foreign Application Priority Data
Nov. 14, 2024 (JP) 2024-199126

(51) Int. Cl. B07C 5/34; B65G 43/08; B65G 47/49; G06K 7/10

(52) U.S. Cl. CPC B07C 5/3412; B65G 43/08; B65G 47/49; G06K 7/10366; B65G 2203/0216; B65G 2203/046

(57) ABSTRACT

An article inspection system includes an inspection unit that inspects quality of a transported article according to an inspection condition corresponding to the article and a sorting unit that sorts the article in a predetermined direction according to an inspection result of the inspection unit. An ID tag is attached to the article. ID tag writing means of the inspection unit writes determination information of the inspection result to the ID tag. Sorting control means controls sorting means based on the determination information written to the ID tag such that the article, from which OK information has been read, is sorted in a good article direction.

### TECHNICAL FIELD

The present invention relates to an article inspection system that inspects quality of a transported article according to an inspection condition corresponding to the article and sorts the article in a predetermined direction according to an inspection result.

### BACKGROUND ART

In the related art, various forms of article inspection devices are known that inspect the quality of a transported article according to an inspection condition corresponding to the article and sort the article in a predetermined direction according to an inspection result.

For example, an article inspection device disclosed in the following Patent Document 1 discharges articles as defective articles to an NG box for each type of NG to sort the articles.

However, in this type of article inspection device, an article determined to be an NG article may be sent for re-inspection depending on the type of NG in a plurality of inspection items. For example, when the article is an NG article due to a missing part, it is preferable to send the article for re-inspection to avoid waste. In addition, when the article is an NG article due to excess weight, a correction process may be performed to adjust the article to appropriate weight, and the article may be sent for re-inspection.

### Related art Document

### Patent Document

[Patent Document 1] JP-A-2011-206710

### Disclosure of the Invention

### Problem that the Invention is to Solve

However, when an operator retrieves a defective article from the NG box and moves the defective article to a re-inspection lane in order to perform the above-described re-inspection, there is a case where the defective article is mistakenly returned to a regular lane, the article previously determined to be the defective article is transported as an OK article to a post-stage device and is processed as a good article in the post-stage device, and the defective article is sent to the downstream side of the post-stage device.

Therefore, the present invention has been made in view of the above problems, and an object of the present invention is to provide an article inspection system that can prevent a defective article from being sent to a downstream side of a post-stage device.

[Means for solving the problem]

In order to achieve the above object, according to an aspect of the present invention, there is provided an article inspection system including: an inspection unit that inspects quality of a transported article according to an inspection condition corresponding to the article; a sorting unit that sorts the article in a predetermined direction according to an inspection result of the inspection unit; ID tag writing means for writing determination information of the inspection result to an ID tag attached to the article; and sorting control means for performing control to sort the article based on the determination information written to the ID tag.

In addition, in the article inspection system according to the aspect of the present invention, the ID tag writing means may perform overwriting for each inspection content of the article.

Further, the article inspection system according to the aspect of the present invention may further include information locking means for prohibiting rewriting of final information written to the ID tag.

Furthermore, the article inspection system according to the aspect of the present invention may further include ID tag information acquisition means for reading the determination information written to the ID tag, and the sorting control means may perform control to sort the article in a good article direction when the determination information read from the ID tag is OK information.

Moreover, in the article inspection system according to the aspect of the present invention, the ID tag may be a read-write RDID tag.

In addition, in the article inspection system according to the aspect of the present invention, the inspection unit may include the ID tag writing means, and the sorting unit may include the sorting control means.

Further, in the article inspection system according to the aspect of the present invention, the sorting unit may include the information locking means.

### Advantage of the Invention

According to the present invention, the post-stage device can reliably determine whether or not the transported article is a good article from the latest information of the read-write ID tag attached to the article. Therefore, it is possible to prevent a defective article from being sent out.

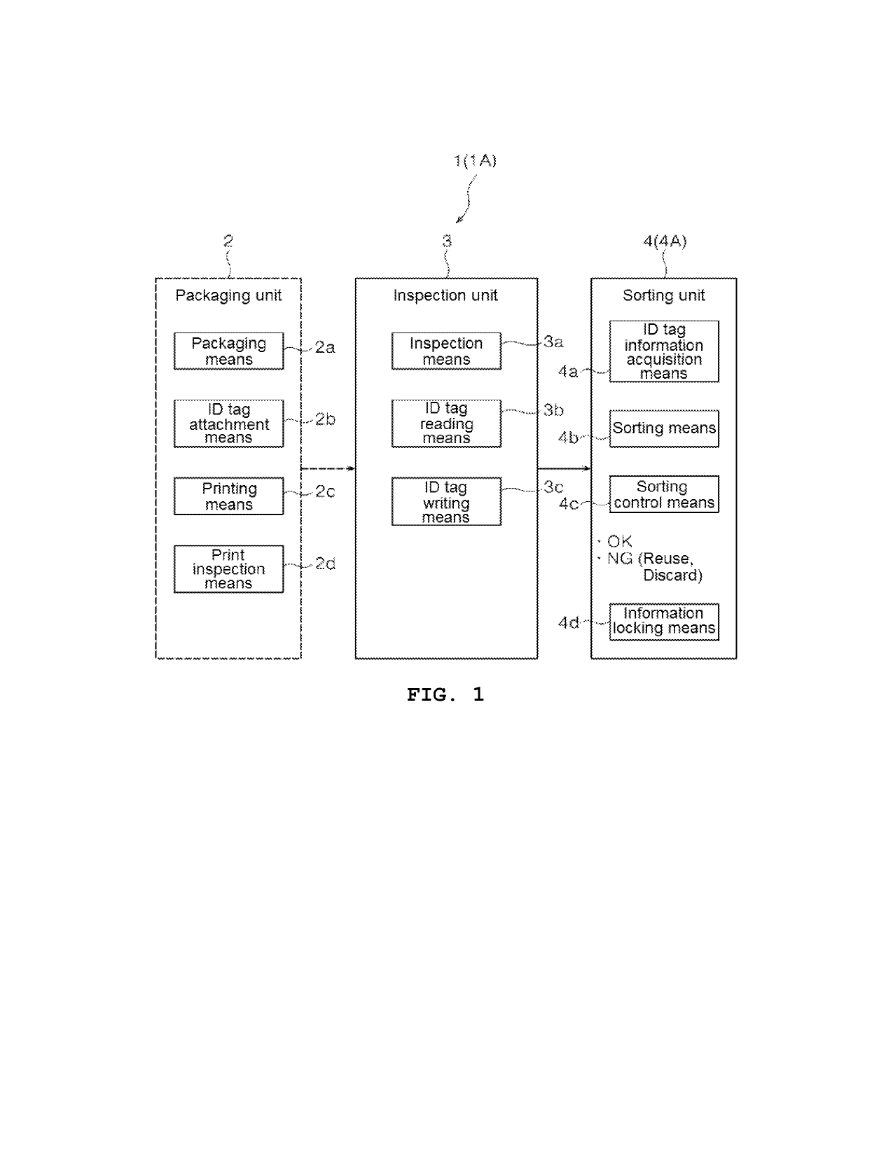

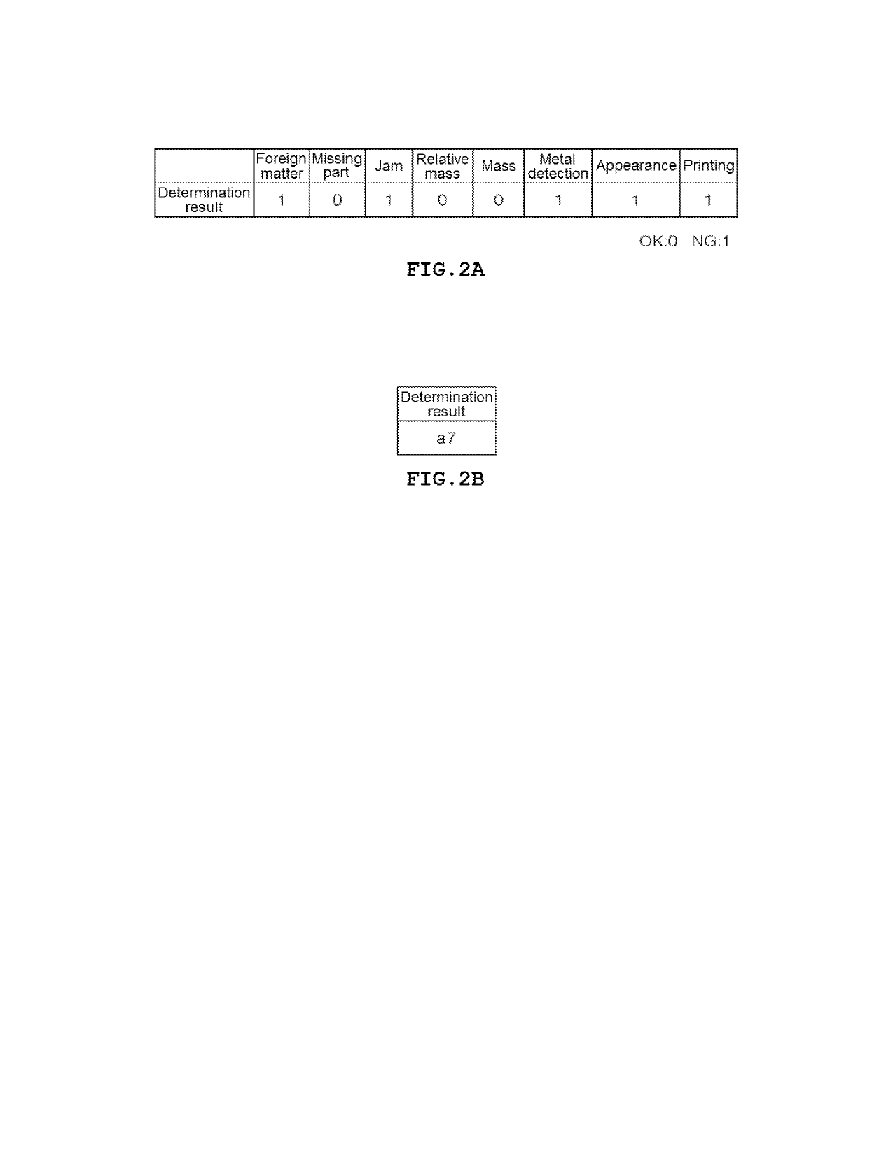

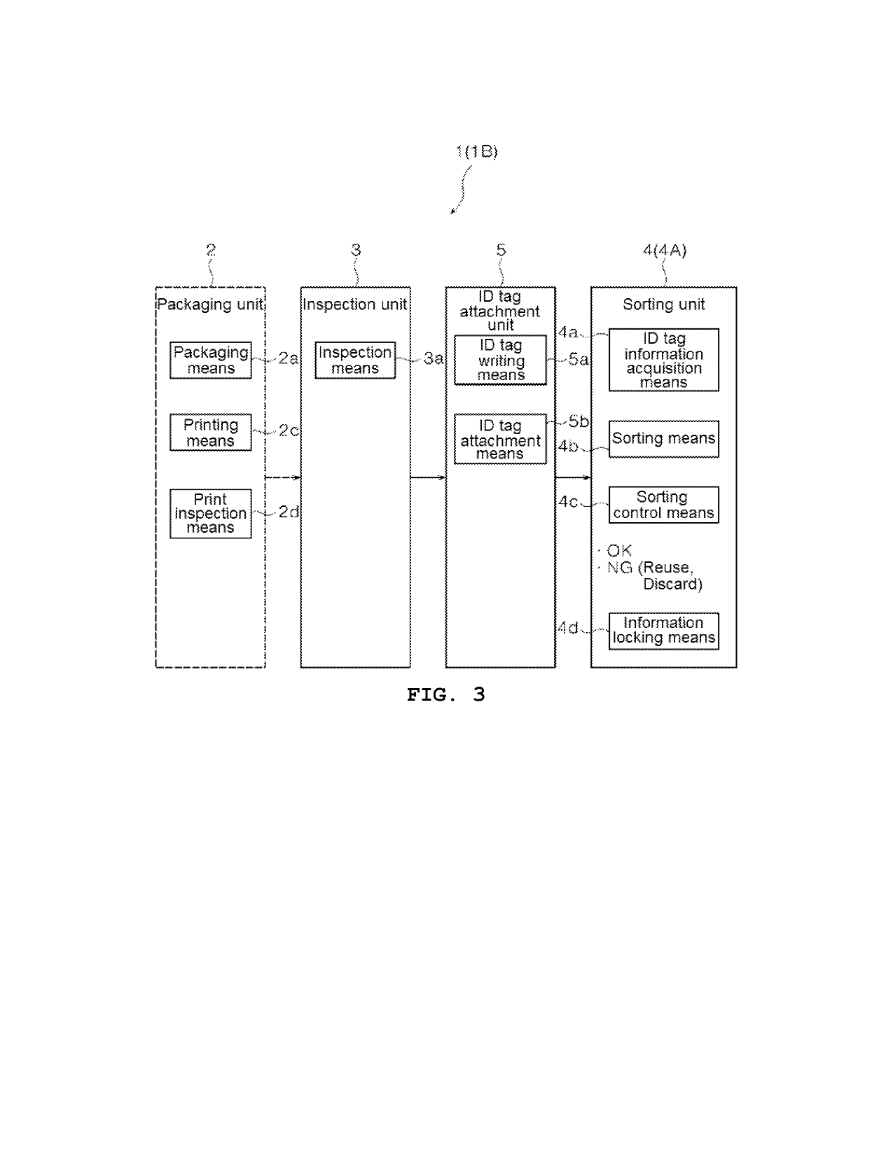

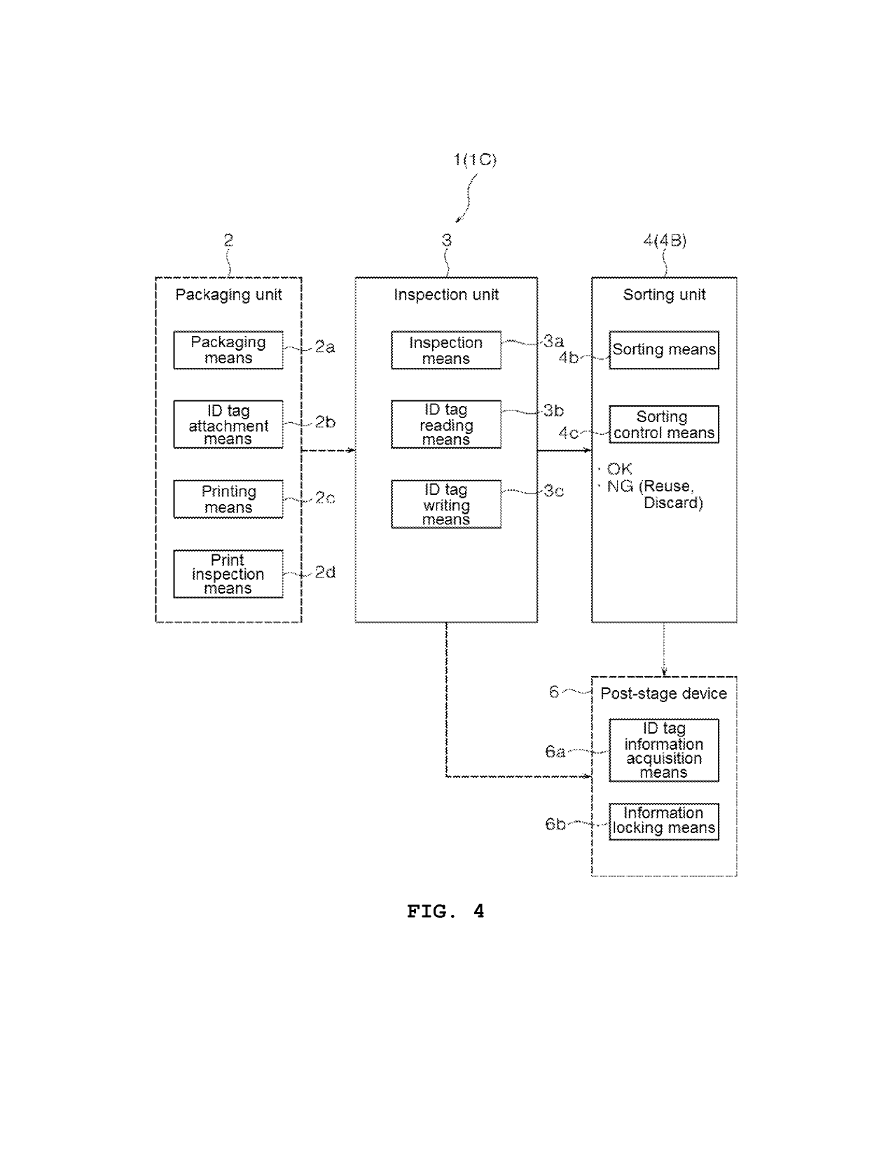

### BRIEF DESCRIPTION OF THE DRAWINGS

[FIG. 1] FIG. 1 is a block diagram showing a schematic configuration of a first embodiment of an article inspection system according to the present invention.

[FIGS. 2A and 2B] FIGS. 2A and 2B are diagrams showing an example of information written to an ID tag in the article inspection system according to the present invention.

[FIG. 3] FIG. 3 is a block diagram showing a schematic configuration of a second embodiment of the article inspection system according to the present invention.

[FIG. 4] FIG. 4 is a block diagram showing a schematic configuration of a third embodiment of the article inspection system according to the present invention.

### BEST MODE FOR CARRYING OUT THE INVENTION

Hereinafter, embodiments of the present invention will be described in detail with reference to the accompanying drawings.

An article inspection system according to the present invention is incorporated into, for example, a manufacturing line (not shown), in which articles as inspection objects, such as raw meat, fish, processed food, and pharmaceuticals, are transported, inspects a foreign matter contained in an article, a defect, an appearance defect, and the like, and inspects the quality of the article, such as whether or not the weight of the article is within a prescribed range. The article inspection system inspects the quality of the transported article according to inspection conditions (the shape, size, ability, product form, length, and thickness of the article, a belt speed, a sorting method, and the like) corresponding to the article and sorts the article in a predetermined direction according to inspection results.

First, a configuration of a first embodiment of the article inspection system will be described with reference to FIG. 1. As shown in FIG. 1, an article inspection system 1 (1A) according to the first embodiment includes an inspection unit 3 and a sorting unit 4 (4A), and a packaging unit 2 is disposed in a stage before the inspection unit 3.

As shown in FIG. 1, the packaging unit 2 is provided as a pre-stage device of the article inspection system 1A and includes packaging means 2a, ID tag attachment means 2b, printing means 2c, and print inspection means 2d.

For example, the packaging means 2a cuts a long film wound around a roll to a predetermined length according to the size of an article, heat-seals an end part to form a bag, and encloses a content (raw material) with a predetermined weight discharged from a filling machine (not shown) in the bag to package the article.

The ID tag attachment means 2b attaches an ID tag, in which information (information such as an article type and the size, quantity, and weight of the content contained in the package) of the article has been written, to the bag of the article packaged by the packaging means 2a. In addition, in this stage, the information of the article may not be written to the ID tag, and an ID tag in an initial format (a state in which information can be read and written) may be attached to the bag of the article.

The ID tag used in the present embodiment is capable of wireless reading and writing of data using radio waves (electromagnetic waves) and is configured as a read-write radio frequency identification (RFID) tag.

The printing means 2c prints identification information for identifying each article, such as a barcode, a two-dimensional code, or a serial number, on the article that has been packaged by the packaging means 2a and has the ID tag attached to the bag.

Further, the printing is, for example, directly printing the identification information at a predetermined position, such as a side surface or a bottom surface of the packaged article, or attaching a label on which the identification information has been printed. An aspect of the printing (the color or size of the printing) is appropriately set within a range that ensures the required readability, according to the shape of the article or the design of the packaging.

The print inspection means 2d inspects the reading of the identification information printed on the packaged article by the printing means 2c and discharges the article as a well-packaged article with no printing defects when the identification information is read correctly.

Further, in the present embodiment and a second embodiment which will be described below, the printing means 2c and the print inspection means 2d are described as a part of the packaging unit 2. However, the printing means 2c and the print inspection means 2d may be separately configured as a printer and a print inspection device, respectively.

As shown in FIG. 1, the inspection unit 3 is provided in a stage behind the packaging unit 2 and includes inspection means 3a, ID tag reading means 3b, and ID tag writing means 3c.

The inspection means 3a is configured to obtain a detection signal corresponding to the type or size of the foreign matter included in the article or a detection signal corresponding to the weight of the article. Then, determination means (not shown) performs a quality determination of whether or not a foreign matter is included in the article, whether or not the weight of the article is within a predetermined range, or the like based on the detection signal, and an inspection result (the result of the quality determination) is displayed on a display operation unit (not shown).

When the inspection unit 3 is configured as a metal detection device, the inspection means 3a is configured to generate an alternating magnetic field of a predetermined frequency and to detect whether or not metal is contained in the article from a detection signal corresponding to a change in the magnetic field due to the article passing through the alternating magnetic field. Furthermore, a configuration may be adopted in which the metal contained in the article is magnetized by a magnetizer, such as a magnet, and residual magnetism of the magnetized metal is detected by a magnetic sensor.

When the inspection unit 3 is configured as an X-ray foreign matter detection device, the inspection means 3a is configured to include an X-ray generation source and an X-ray detector. The X-ray detector detects X-rays transmitted through the article when the article is irradiated with the X-rays from the X-ray generation source, and the inspection means 3a detects, for example, the foreign matter contained in the article and the mass, defects, and shape defects of the article from a detection signal corresponding to the amount of transmission of the X-rays. The X-ray detector is, for example, a line sensor array including a plurality of photodiodes that are arranged in a line shape in a direction orthogonal to a transport direction of the article transported by a transport unit (not shown) and a scintillator that is provided on the photodiodes. The scintillator receives the X-rays transmitted through the article and converts the X-rays into light, and the photodiodes disposed below the scintillator convert the light into an electric signal. In addition, a direct-conversion-type semiconductor element may be used as the X-ray detector.

When the inspection unit 3 is configured as a weight measurement device, the inspection means 3a is configured to measure the weight of an article placed on a weighing platform, which is a part of a transport unit (not shown), using a load sensor configured as a weighing mechanism, such as an electromagnetic balance mechanism, which is disposed below the weighing platform, to determine whether or not a measured value obtained by the weighing is within a reference range, and to sort good articles within the reference range and defective articles outside the reference range. The load sensor may be a weighing mechanism capable of measuring weight and may be configured as, for example, a weighing mechanism such as a differential transformer mechanism or a strain gauge mechanism.

Further, in addition to the above, the inspection means 3a can also be configured as an inspection device that inspects appearance defects or contained foreign matters from an image captured by a camera. Then, the inspection unit 3 may also be configured as a composite inspection device obtained by selectively combining the metal detection device, the X-ray foreign matter detection device, the weight measurement device, the inspection device using a camera, and the like as the inspection means 3a.

The ID tag reading means 3b reads the information of the ID tag attached to the article to be inspected. Furthermore, when the article to be inspected is transported to the inspection unit 3 for the first time, the ID tag reading means 3b reads the information of the article or the information in the initial format as the information of the ID tag attached to the article. In addition, when the article to be inspected was transported in the past, the ID tag reading means 3b reads the information of the article and determination information of inspection results for each inspection content as the information of the ID tag attached to the article at the time when the article was transported to the inspection unit 3.

After the ID tag reading means 3b reads the information of the ID tag attached to the article to be inspected, the ID tag writing means 3c overwrites the information of the article (information such as an article type and the size, quantity, and weight of the content enclosed in the package) and the determination information of the latest inspection results for each inspection content by the inspection unit 3 to the ID tag.

Here, the information (information that can be encoded) written to the ID tag attached to the article is a combination of numbers (0 to 9) and letters (a to f). In addition to a code expressed in a binary number (a number of 0 or 1), a code expressed in a decimal number (a combination of the numbers from 0 to 9) or a hexadecimal number (a combination of the numbers from 0 to 9 and the letters a to f) can be written.

Further, Hiragana, kanji, letters other than a to f, other symbols, and the like are invalid, and the number of digits is a multiple of 4 and is expressed by a multiple of four digits, such as 4 digits, 8 digits, 12 digits, or 16 digits. The capacity of a general RFID tag writing area is 96 bits (24 digits) or 128 bits (32 digits).

FIGS. 2A and 2B show an example of the information written to the ID tag. FIG. 2A shows an example in which the determination results for each inspection content of the article are written in binary numbers (“0”: OK, “1”: NG). Specifically, the determination result for a foreign matter: "1", the determination result for a missing part: "0", the determination result for jam: "1", the determination result for relative mass: "0", the determination result for mass: "0", the determination result for metal detection: "1", the determination result for appearance: "1", and the determination result for printing: "1" are written as the determination information of the latest inspection results to the ID tag. That is, when an inspection result by the inspection unit 3 shows a good article, "0", which is OK information, is written to the ID tag. When the inspection result by the inspection unit 3 shows a defective article, "1", which is NG information, is written to the ID tag.

FIG. 2B is an example in which the determination result for the inspection content of the article is written in a hexadecimal number, and the determination result for the inspection content is written in a hexadecimal number "a7" to the ID tag.

As shown in FIG. 1, the sorting unit 4 (4A) is provided in a stage behind the inspection unit 3 and includes ID tag information acquisition means 4a, sorting means 4b, sorting control means 4c, and information locking means 4d.

When the article to be inspected, to which the ID tag has been attached, is transported from the inspection unit 3, the ID tag information acquisition means 4a reads the information (including the OK information) written to the ID tag of the article to be inspected and acquires the information.

The sorting means 4b sorts the article to be inspected in a predetermined direction under the control of the sorting control means 4c for controlling sorting according to the inspection results of the inspection unit 3 (the determination information of the latest inspection results for each inspection content by the inspection unit 3 written to the ID tag of the article to be inspected). The sorting means 4b is configured to selectively include air jet sorting means, drop-out sorting means, up-out sorting means, and flipper sorting means as known sorting means.

Each sorting means will be described in brief. The air jet sorting means is a type that blows air from one side of a transported article to discharge the article to the other side, thereby sorting a defective article. The drop-out sorting means is a type that tilts a conveyor downward to drop the article such that the article is discharged outside a transport path, thereby sorting the defective article. The up-out sorting means is a type that tilts upward the upstream side of the conveyor in a transport direction to drop the article such that the article is discharged outside the transport path, thereby sorting the defective article. The flipper sorting means is a type that swings an arm along a transport surface of the conveyor to discharge the article to the side of the conveyor, thereby sorting the defective article. Further, in each sorting means, the article sorted in a good article direction continues straight along the transport path and is discharged without diversion. For example, the article is sent to a packaging operation in a final process.

The sorting control means 4c reads the determination information of the inspection result from the ID tag and controls the sorting means 4b such that the article is sorted in the good article direction when the determination information is the OK information (does not include the NG information) and the article is sorted in a defective article direction when the determination information is the NG information (includes the NG information).

For example, when a plurality of inspections are performed by a plurality of inspection units 3 or when the inspected article that has undergone all inspections including the final inspection is transferred to the packaging process before the final shipping process, the information locking means 4d prohibits the rewriting of final information of the ID tag attached to the article.

Next, an operation when the article is inspected by the article inspection system 1A configured as described above will be described.

First, the packaging means 2a of the packaging unit 2 encloses a content with a predetermined weight in the bag cut to a predetermined length according to the size of the article to be inspected and packages the article.

Then, the ID tag attachment means 2b of the packaging unit 2 attaches the ID tag, to which information (information such as an article type and the size, quantity, and weight of the content enclosed in the package) of the article has been written, to the bag of the packaged article to be inspected. In addition, the ID tag in the initial format may be attached to the bag of the article.

Then, the printing means 2c of the packaging unit 2 prints identification information for identifying each article, such as a barcode, a two-dimensional code, or a serial number, on the article to be inspected to which the ID tag has been attached.

Then, the print inspection means 2d of the packaging unit 2 reads the identification information printed on the packaged article to be inspected and performs inspection. Then, when the identification information is read correctly, the article is discharged as a well-packaged article with no printing defects.

Then, the inspection means 3a of the inspection unit 3 appropriately performs inspection corresponding to the inspection content for the article to be inspected, for example, inspection of whether or not metal is contained, inspection of whether or not a foreign matter is contained, inspection of whether or not the weight is within the reference range, and inspection of whether or not an appearance defect is present.

Then, the ID tag reading means 3b of the inspection unit 3 reads the information of the ID tag attached to the article to be inspected. Then, the ID tag writing means 3c of the inspection unit 3 overwrites the information of the article (information such as the article type and the size, quantity, and weight of the content enclosed in the package) and the determination information of the latest inspection results for each inspection content by the inspection unit 3 to the ID tag from which the information has been read by the ID tag reading means 3b.

Then, when the article to be inspected, to which the ID tag has been attached, is transported from the inspection unit 3, the ID tag information acquisition means 4a of the sorting unit 4 (4A) reads the information (the information of the article and the determination information of the latest inspection results for each inspection content by the inspection unit 3) written to the ID tag of the article and acquires the information.

Then, the sorting means 4b of the sorting unit 4 (4A) sorts the article to be inspected in a predetermined direction according to the determination information of the latest inspection results for each inspection content by the inspection unit 3 which has been written to the ID tag of the article to be inspected, under the control of the sorting control means 4c.

The sorting means 4b of the sorting unit 4 (4A) sorts the article to be inspected in the good article direction when the determination information of all of the inspection results is the OK information and sorts the article to be inspected in the defective article direction when any NG information is present in the determination information of the inspection results.

Then, the information locking means 4d of the sorting unit 4 (4A) prohibits the rewriting of the final information of the ID tag attached to the inspected article that has undergone all of the inspections. Then, the inspected article is sent to the final shipping process via the packaging process.

Next, a configuration of a second embodiment of the article inspection system will be described with reference to FIG. 3. Further, in the description of the article inspection system according to the second embodiment, configurations having the same or similar functions as those in the article inspection system 1 (1A) according to the first embodiment are denoted by the same reference numerals.

As shown in FIG. 3, an article inspection system 1 (1B) according to the second embodiment includes an inspection unit 3, a sorting unit 4 (4A), and an ID tag attachment unit 5, and a packaging unit 2 is disposed in a stage before the inspection unit 3.

In FIG. 3, the packaging unit 2 is provided as a pre-stage device of the article inspection system 1B and includes packaging means 2a, printing means 2c, and print inspection means 2d.

As in the first embodiment, the packaging means 2a cuts a long film wound around a roll to a predetermined length according to the size of an article, heat-seals an end part to form a bag, and encloses a content (raw material) with a predetermined weight discharged from a filling machine (not shown) in the bag to package the article.

The printing means 2c prints identification information for identifying each article, such as a barcode, a two-dimensional code, or a serial number, on the article that has been packaged by the packaging means 2a and has the ID tag attached to the bag.

The print inspection means 2d inspects the reading of the identification information printed on the packaged article by the printing means 2c and discharges the article as a well-packaged article with no printing defects when the identification information is read correctly.

As shown in FIG. 3, the inspection unit 3 is provided in a stage behind the packaging unit 2 and includes inspection means 3a. As in the first embodiment, the inspection means 3a is configured to obtain a detection signal corresponding to the type or size of a foreign matter included in the article or a detection signal corresponding to the weight of the article. Then, determination means (not shown) performs a quality determination of whether or not a foreign matter is included in the article, whether or not the weight of the article is within a predetermined range, or the like based on the detection signal, and an inspection result (the result of the quality determination) is displayed on a display operation unit (not shown).

The inspection means 3a adopts the configuration described in the first embodiment in each of the case where the inspection unit 3 is configured as the metal detection device, the case where the inspection unit 3 is configured as the X-ray foreign matter detection device, and the case where the inspection unit 3 is configured as the weight measurement device.

Further, in addition to the above, the inspection means 3a can also be configured as an inspection device that inspects appearance defects or contained foreign matters from an image captured by a camera. In addition, the inspection unit 3 may be configured as a composite inspection device obtained by selectively combining the metal detection device, the X-ray foreign matter detection device, the weight measurement device, the inspection device using a camera, and the like as the inspection means 3a.

Furthermore, the article inspection system 1B according to the second embodiment is configured such that ID tag attachment means 5b, which will be described below, in the ID tag attachment unit 5 attaches an ID tag to the article inspected by the inspection unit 3. Therefore, when the article, to which the ID tag has been attached, is erroneously transported to the inspection unit 3, control is performed such that the article, to which the ID tag has been attached, is excluded without being inspected.

As shown in FIG. 3, the ID tag attachment unit 5 is provided in a stage behind the inspection unit 3 and includes ID tag writing means 5a and the ID tag attachment means 5b.

The ID tag writing means 5a writes information of the article (information such as an article type and the size, quantity, and weight of the content enclosed in the package) and determination information of the latest inspection results for each inspection content by the inspection unit 3 to the ID tag attached to the inspected article.

The ID tag attachment means 5b attaches the ID tag, to which the information (the information of the article and the determination information of the latest inspection results for each inspection content by the inspection unit 3) has been written by the ID tag writing means 5a, to the corresponding bag of the inspected article.

As shown in FIG. 3, the sorting unit 4 (4A) is provided in a stage behind the ID tag attachment unit 5 and includes ID tag information acquisition means 4a, sorting means 4b, sorting control means 4c, and information locking means 4d.

As in the first embodiment, when the article to be inspected, to which the ID tag has been attached, is transported from the inspection unit 3, the ID tag information acquisition means 4a reads the information (including OK information) written to the ID tag of the article and acquires the information.

As in the first embodiment, the sorting means 4b sorts the article to be inspected in a predetermined direction according to the inspection results of the inspection unit 3 (the determination information of the latest inspection results for each inspection content by the inspection unit 3 written to the ID tag of the article to be inspected). The sorting means 4b is configured to selectively include air jet sorting means, drop-out sorting means, up-out sorting means, and flipper sorting means as known sorting means. In addition, since the configuration of each sorting means is the same as that in the first embodiment, a description thereof will be omitted.

As in the first embodiment, the sorting control means 4c reads the determination information of the inspection results from the ID tag and controls the sorting means 4b such that the article is sorted in the good article direction when the determination information is the OK information (does not include the NG information) and the article is sorted in the defective article direction when the determination information is the NG information (includes the NG information).

As in the first embodiment, for example, when a plurality of inspections are performed by a plurality of inspection units 3 or when the inspected article that has undergone all inspections including the final inspection is transferred to the packaging process before the final shipping process, the information locking means 4d prohibits the rewriting of the final information of the ID tag attached to the article.

Next, an operation when the article is inspected by the article inspection system 1B configured as described above will be described.

First, the packaging means 2a of the packaging unit 2 encloses a content with a predetermined weight in the bag cut to a predetermined length according to the size of the article to be inspected and packages the article.

Then, the printing means 2c of the packaging unit 2 prints identification information for identifying each article, such as a barcode, a two-dimensional code, or a serial number, on the article to be inspected to which the ID tag has been attached.

Then, the print inspection means 2d of the packaging unit 2 reads the identification information printed on the packaged article to be inspected and performs inspection. Then, when the identification information is read correctly, the article is discharged as a well-packaged article with no printing defects.

Then, the inspection means 3a of the inspection unit 3 appropriately performs inspection corresponding to the inspection content for the article to be inspected, for example, inspection of whether or not metal is contained, inspection of whether or not a foreign matter is contained, inspection of whether or not the weight is within the reference range, and inspection of whether or not an appearance defect is present.

Then, the ID tag writing means 5a of the ID tag attachment unit 5 writes the information of the article (information such as an article type and the size, quantity, and weight of the content enclosed in the package) and the determination information of the latest inspection results for each inspection content by the inspection unit 3 to the ID tag attached to the inspected article.

Then, the ID tag attachment means 5b of the ID tag attachment unit 5 attaches the ID tag, to which the information (the information of the article and the determination information of the latest inspection results for each inspection content by the inspection unit 3) has been written by the ID tag writing means 5a, to the corresponding bag of the inspected article.

Then, when the article to be inspected, to which the ID tag has been attached, is transported from the inspection unit 3, the ID tag information acquisition means 4a of the sorting unit 4 (4A) reads the information (the information of the article and the determination information of the latest inspection results for each inspection content by the inspection unit 3) written to the ID tag of the article and acquires the information.

Then, the sorting means 4b of the sorting unit 4 (4A) sorts the article to be inspected in a predetermined direction according to the determination information of the latest inspection results for each inspection content by the inspection unit 3 which has been written to the ID tag of the article to be inspected, under the control of the sorting control means 4c.

The sorting means 4b of the sorting unit 4 (4A) sorts the article to be inspected in the good article direction when the determination information of all of the inspection results is the OK information and sorts the article to be inspected in the defective article direction when any NG information is present in the determination information of the inspection results.

Then, the information locking means 4d of the sorting unit 4 (4A) prohibits the rewriting of the final information of the ID tag attached to the inspected article that has undergone all of the inspections. Then, the inspected article is sent to the final shipping process via the packaging process.

Next, a configuration of a third embodiment of the article inspection system will be described with reference to FIG. 4. Further, in the description of the article inspection system according to the third embodiment, configurations having the same or similar functions as those in the article inspection system 1 (1A) according to the first embodiment are denoted by the same reference numerals.

As shown in FIG. 4, an article inspection system 1 (1C) according to the third embodiment includes an inspection unit 3 and a sorting unit 4 (4B). A packaging unit 2 is disposed in a stage before the inspection unit 3, and a post-stage device 6 is disposed in a stage behind the inspection unit 3.

Since the packaging unit 2 and the inspection unit 3 of the article inspection system 1C according to the third embodiment have the same configurations as the packaging unit 2 and the inspection unit 3 of the article inspection system 1A according to the first embodiment, a description thereof will be omitted.

The sorting unit 4 (4B) of the article inspection system 1C according to the third embodiment includes sorting means 4b and sorting control means 4c and is configured such that the ID tag information acquisition means 4a and the information locking means 4d included in the sorting unit 4 (4A) of the article inspection system 1A according to the first embodiment are omitted.

The sorting means 4b sorts the article to be inspected in a predetermined direction under the control of the sorting control means 4c for controlling sorting according to the inspection results of the inspection unit 3 (the determination information of the latest inspection results for each inspection content by the inspection unit 3 written to the ID tag of the article to be inspected). The sorting means 4b is configured to selectively include air jet sorting means, drop-out sorting means, up-out sorting means, and flipper sorting means as known sorting means.

The sorting control means 4c controls the sorting means 4b such that, in a case where the inspection result of the inspection unit 3 does not include any defects and writing to the ID tag is performed normally, the article is sorted in the good article direction and that the article is sorted in the defective article direction in the other cases. The article in which the determination information of the inspection result has been written to the ID tag is transported to the post-stage device (including the post-stage device 6).

In the article inspection system 1C according to the third embodiment, the post-stage device 6 is a device that is disposed in the stage behind the inspection unit 3, such as a packaging device that packages an inspection object W, a terminal device that manages the inspection result of the entire inspection object W, or a sorting unit that is separate from the sorting unit 4 (4B), and includes ID tag information acquisition means 6a and information locking means 6b.

When the article to be inspected, to which the ID tag has been attached, is transported from the inspection unit 3, the ID tag information acquisition means 6a reads the information (including OK information) written to the ID tag of the article and acquires the information.

For example, when a plurality of inspections are performed by a plurality of inspection units 3 or when the inspected article that has undergone all inspections including the final inspection is transferred to the packaging process before the final shipping process, the information locking means 6b prohibits the rewriting of final information of the ID tag attached to the article.

Next, an operation when the article is inspected by the article inspection system 1C configured as described above will be described. In addition, since the operations of the packaging unit 2 and the inspection unit 3 are the same as those in the article inspection system 1A according to the first embodiment, a description thereof will be omitted.

When the inspection unit 3 inspects the inspection object W, the sorting control means 4c of the sorting unit 4 (4B) controls the sorting means 4b such that, in a case where the inspection result of the inspection unit 3 does not include any defects and writing to the ID tag is performed normally, the article is sorted in the good article direction and that the article is sorted in the defective article direction in the other cases. The article in which the determination information of the inspection result has been written to the ID tag is transported to the post-stage device (including the post-stage device 6).

When the article to be inspected, to which the ID tag has been attached, is transported from the inspection unit 3, the ID tag information acquisition means 6a of the post-stage device 6 reads the information (including the OK information and the NG information) written to the ID tag of the article and acquires the information.

The information locking means 6b of the post-stage device 6 prohibits the rewriting of the final information of the ID tag attached to the inspected article that has undergone all of the inspections. Then, the inspected article is sent to the final shipping process.

In the article inspection systems 1 (1A, 1B, and 1C) according to the above-described embodiments, the configuration in which the packaging unit 2 is disposed in the stage before the inspection unit 3 has been described as an example. However, the present invention is not limited thereto. For example, the present invention can also be applied to a case where there is a molding and processing process in the stage before the inspection unit 3 or a case where there is a raw material process in the stage before the inspection unit 3. That is, in a process of manufacturing a product from a raw material, the present invention can be applied to a work process including the inspection unit 3 and the sorting unit 4.

As described above, according to the present embodiment, it is possible to reliably determine whether or not the transported article is a good article from the latest information of the read-write ID tag attached to the article and to prevent defective articles from being sent to the downstream side of the post-stage device. As a result, even when a defective article is erroneously sent to a post-stage in the article inspection system, in the final shipping process, it is possible to easily specify the article with no OK information from the latest information written to the ID tag of the article to be inspected and to discard the defective article without being sent out.

In addition, reading the information of the ID tag attached to each article returned due to consumer complaints enables the inspection results of the individual articles to be linked to each other. Therefore, it is possible to minimize the scope of product recalls in the event of an issue.

The best mode for carrying out the article inspection system according to the present invention has been described above. However, the present invention is not limited to the description and drawings of this mode. That is, it goes without saying that other modes, embodiments, and operational techniques implemented by those skilled in the art based on this mode are all included within the scope of the present invention.

### DESCRIPTION OF REFERENCE NUMERALS AND SIGNS

1 (1A, 1B, 1C) Article inspection system
2 Packaging unit
2a Packaging means
2b ID tag attachment means
2c Printing means
2d Print inspection means
3 Inspection unit
3a Inspection means
3b ID tag reading means
3c ID tag writing means
4 (4A, 4B) Sorting unit
4a ID tag information acquisition means
4b Sorting means
4c Sorting control means
4d Information locking means
5 ID tag attachment unit
5a ID tag writing means
5b ID tag attachment means
6 Post-stage device
6a ID tag information acquisition means
6b Information locking means

What is claimed is:

1. An article inspection system comprising:
an inspection unit that inspects quality of a transported article according to an inspection condition corresponding to the article;
a sorting unit that sorts the article in a predetermined direction according to an inspection result of the inspection unit;
ID tag writing means for writing determination information of the inspection result to an ID tag attached to the article; and
sorting control means for performing control to sort the article based on the determination information written to the ID tag.

2. The article inspection system according to claim 1,
wherein the ID tag writing means performs overwriting for each inspection content of the article.

3. The article inspection system according to claim 1, further comprising:
information locking means for prohibiting rewriting of final information written to the ID tag.

4. The article inspection system according to claim 1, further comprising:
ID tag information acquisition means for reading the determination information written to the ID tag,
wherein the sorting control means performs control to sort the article in a good article direction when the determination information read from the ID tag is OK information.

5. The article inspection system according to claim 2, further comprising:
information locking means for prohibiting rewriting of final information written to the ID tag.

6. The article inspection system according to claim 1,
wherein the ID tag is a read-write RDID tag.

7. The article inspection system according to claim 1,
wherein the inspection unit includes the ID tag writing means, and
the sorting unit includes the sorting control means.

8. The article inspection system according to claim 3,
wherein the sorting unit includes the information locking means.

9. The article inspection system according to claim 4,
wherein the sorting unit includes the ID tag information acquisition means.

10. The article inspection system according to claim 5,
wherein the sorting unit includes the information locking means.
